(19) United States
(12) Patent Application Publication
(10) Pub. No.: US 2024/0064213 A1
(43) Pub. Date: Feb. 22, 2024

(54) SYSTEMS AND METHODS FOR GENERATING REAL-TIME LOCATION-BASED NOTIFICATIONS

(71) Applicant: Capital One Services, LLC, McLean, VA (US)

(72) Inventors: Apurv BAICHWAL, Washington, DC (US); Shaun Kieran WEBB, Oakland, CA (US); Dan LIN, Arlington, VA (US); Leeyat Bracha TESSLER, Arlington, VA (US); Daniel E. MILLER, Brooklyn, NY (US)

(73) Assignee: Capital One Services, LLC, McLean, VA (US)

(21) Appl. No.: 17/820,895

(22) Filed: Aug. 19, 2022

(51) Int. Cl. H04L 67/52; H04L 67/50; H04W 4/029; G06F 16/9537

(52) U.S. Cl. CPC H04L 67/52; H04L 67/535; H04W 4/029; G06F 16/9537

(57) ABSTRACT

Methods and systems for generating real-time location-based notifications comprising: receiving information regarding a first activity and a first location for a first user, the first location being a location where the first activity was executed by the first user; in response to detecting a second location of a second user being in proximity of the first location, processing the first activity and the first location using a machine learning model to determine a second activity to be executed by the second user, the second user being authorized to access the first activity and the first location for the first user, the second activity being a type of activity that addresses a consequence of the first activity; and generating for display to the second user a notification indicating the second activity for execution.

### BACKGROUND

In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence often relies on large amounts of high-quality data. The process for obtaining this data and ensuring it is high-quality is often complex and time-consuming. Second, despite the mainstream popularity of artificial intelligence, practical implementations of artificial intelligence require specialized knowledge to design, program, and integrate artificial intelligence-based solutions, which limits the amount of people and resources available to create these practical implementations. Finally, results based on artificial intelligence are notoriously difficult to review as the process by which the results are made may be unknown or obscured. This obscurity creates hurdles for identifying errors in the results, as well as improving the models providing the results. These technical problems present an inherent problem with attempting to use an artificial intelligence-based solution to recommend in real time counter activity to be performed by a user based on the user's prior activity.

### SUMMARY

Methods and systems are described herein for novel uses and/or improvements to artificial intelligence applications. As one example, methods and systems are described herein for generating real-time location-based notification for a counter activity to be performed by a user to address one or more consequences from the user's previous activity.

Existing systems fail to account for consequences of a user's activities and do not address such consequences in the form of a counter activity when suggesting further activities for the user. Further, existing systems fail to incorporate real-time location data and combine it with previous user activity to inform their models when generating possible options of counter activities to address consequences of the user's previous activities. The difficulty in adapting artificial intelligence models for this practical benefit faces several technical challenges such as the lack of an infrastructure to incorporate real-time location information into predictions for future activities; the lack of techniques to match the user's previous activities to counter activities designed to address consequences of the user's previous activity; and the pipeline to deliver real-time location-based notifications to a user for counter activity to be performed by the user.

To overcome these technical deficiencies in adapting artificial intelligence models for this practical benefit, methods and systems are disclosed herein that, based on detecting that a current location of the user is in proximity of the user's previous location, process the user's previous activity and associated location data using a machine learning model to determine a measure of a consequence of the user's previous activity, and query a database using the determined measure to determine a counter activity to be executed by the user. Accordingly, the methods and systems provide a real-time location-based notification for a counter activity to address consequences of the user's previous activity.

In some aspects, the systems and methods described herein include a method, comprising: receiving information regarding a user activity and a previous location for a user, the previous location being a location where the user activity was executed by the user; at a time subsequent to execution of the user activity by the user, detecting that a current location of the user is in proximity of the previous location; in response to detecting that the current location of the user is in proximity of the previous location, processing the user activity and the previous location using a machine learning model to determine a measure of a consequence of the user activity; querying a database using the measure to determine a counter activity to be executed by the user, the counter activity being a type of activity that addresses a consequence of the user activity; and during a time period the user is present at the current location, generating for display, in a mobile application, a notification to the user indicating the counter activity for execution.

In some aspects, the systems and methods described herein include a method, comprising: receiving information regarding a first activity and a first location for a first user, the first location being a location where the first activity was executed by the first user; in response to detecting a second location of a second user being in proximity of the first location, processing the first activity and the first location using a machine learning model to determine a second activity to be executed by the second user, the second user being authorized to access the first activity and the first location for the first user, the second activity being a type of activity that addresses a consequence of the first activity; and generating for display to the second user a notification indicating the second activity for execution.

In some aspects, the systems and methods described herein include a method, comprising: receiving information regarding a first activity and a first location for a user, the first location being a location where the first activity was executed by the user; in response to detecting a second location of the user being in proximity of the first location, processing the first activity and the first location using a machine learning model to determine a second activity to be executed by the user, the second activity being a type of activity that is different from the first activity; and generating for display to the user a notification indicating the second activity for execution.

Various other aspects, features, and advantages of the systems and methods described herein will be apparent through the detailed description and the drawings attached hereto. It is also to be understood that both the foregoing general description and the following detailed description are examples and are not restrictive of the scope of the systems and methods described herein. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for components of a system for generating real-time location-based notifications in a mobile application, in accordance with one or more embodiments.

FIG. 2 shows an illustrative user interface for displaying real-time location-based notifications in a mobile application, in accordance with one or more embodiments.

FIG. 3 shows illustrative components for a system used to generate real-time location-based notifications, in accordance with one or more embodiments.

FIG. 4 shows a flowchart of the steps involved in generating real-time location-based notifications, in accordance with one or more embodiments.

### DETAILED DESCRIPTION

In the following description, for the purposes of explanation, numerous specific details are set forth in order to provide a thorough understanding of the embodiments of the systems and methods described herein. It will be appreciated, however, by those having skill in the art that the embodiments may be practiced without these specific details or with an equivalent arrangement. In other cases, well-known structures and devices are shown in block diagram form in order to avoid unnecessarily obscuring the embodiments.

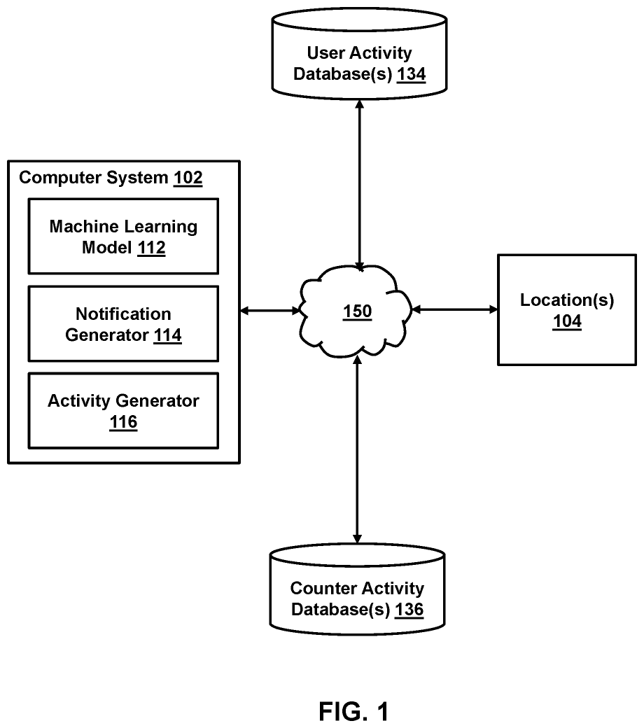

FIG. 1 shows an illustrative diagram for a system which combines data for locations and activities and utilizes a machine learning model to generate recommendations, in accordance with one or more embodiments. System 150 may contain computer system 102, comprising machine learning model 112, notification generator 114, and activity generator 116; user activity database(s) 134; counter activity database(s) 136; and may access user location 104.

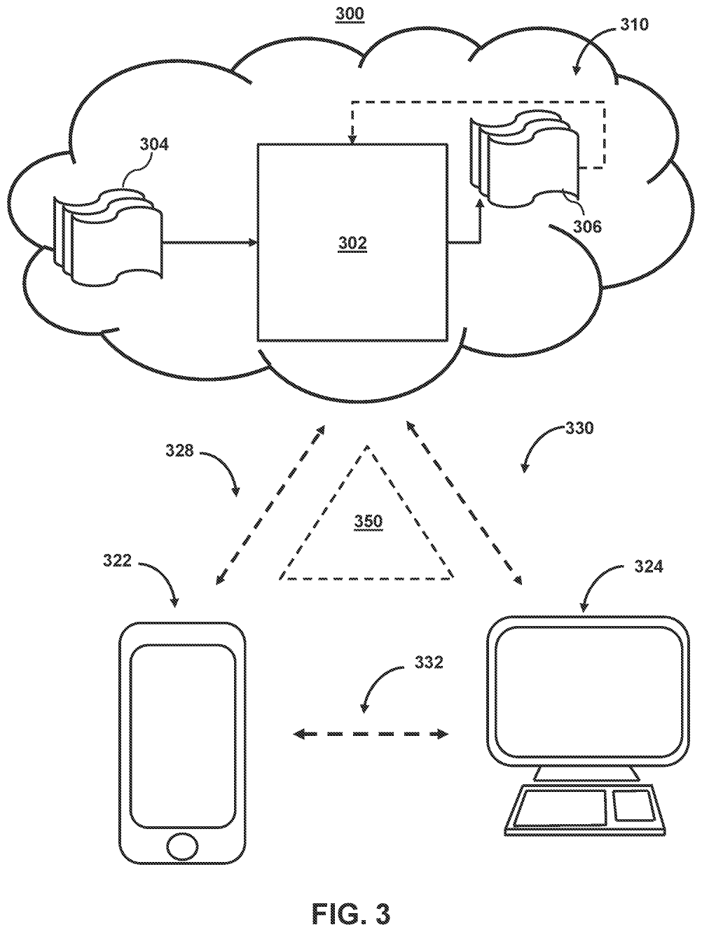

System 150 may access user location 104, where a first user activity took place. The system may do this by communicating with a user device using one or more components described in FIG. 3 below to receive information regarding user activity. Such information may include but is not limited to the activity the user engaged in, the location of the activity, the type or category of the activity, the time at which the user engaged in the activity, or any associated metadata. The system may, for example, receive data from a payment terminal that a credit card transaction has been posted to the account of a user at a particular store. The system may determine that the user engaged in transactional activity at the location of the store. The system may additionally acknowledge the contents of the purchase, and may note the time, in addition to any relevant metadata. In some embodiments, the system may communicate with one or more mobile applications on a user device, which may have GPS tracking enabled. The system may receive data from these applications regarding activities in which the user engages. The system may also access the user's real-time location through these applications. After recording information regarding the first user activity, including its time and location, the system may determine a time buffer for a counter activity. For example, the system may choose to wait for 24 hours before making a suggestion to the user should they return to the location of the first activity. After the time buffer has passed, the system may detect the user's location being in proximity of the first activity's location. It may calculate the distance between the user's real-time location and the known location of the first activity. If the distance is less than a set threshold, the system may determine the user is in proximity of the prior location.

System 150 may access user activity database(s) 134, where each documented activity of a multitude of users is recorded. For example, a user activity may include purchasing goods or services, such as buying fertilizer for a home garden or having dinner at a restaurant. In another example, a user activity may include taking a flight to a vacation destination or a car ride to a doctor's appointment. Some or all of the data in user activity database(s) 134 may be infused with metadata, including but not limited to the merchant at which a purchase was made in relation to or comprising the user activity, the type or category of the activity, the location of the activity, the recurrence of similar activities for a particular user, and similar activities by different users. The system may receive data about user activities from a mobile application having user permissions to collect such data. For example, the mobile application may be included in a banking or credit card application configured to collect transaction data. In another example, the system may receive transaction data directly from a banking or credit card company. The system may use one or more machine learning models to perform feature engineering or classification on user activity database(s) 134; for example, a model may label activities with a type or category where such labels are missing. The system may also generate feature vectors representing one or more activities in user activity database(s) 134 to be processed by, for example, machine learning model 112.

System 150 may access counter activity database(s) 136, which lists activities gathered from various databases and sources which the system may recommend to a user as a countermeasure of their previous activities. For example, it may contain carbon offsetting initiatives, environmental protection initiatives, and other socially-conscious programs. The system may use one or more machine learning models to perform feature engineering or classification on counter activity database(s) 136. It may classify the activities into categories, which may correspond to sub-divisions of segments of user interest. The category of a counter activity may be infused as metadata into its entry in counter activity database(s) 136. Each counter activity in the database may be associated with a score for impact, which may be obtained from a third party.

System 150 contains machine learning model 112, which may receive data including a user activity, a location for the activity, and any associated metadata. The system may combine the category of the activity, its location, and any metadata to form a feature vector. The system is trained to match such feature vectors with an appropriate category of counteractivity. The system may then forward its outputs to activity generator 116. Machine learning model 112 may be trained on data contained in counter activity database(s) 136 and/or user activity database(s) 134, some of which may be labeled, or contain metadata that may inform the model in training.

System 150 contains activity generator 116, which may take input from machine learning model 112 in the form of a vector, for determining the selection of counter activities to suggest to the user. The vector may represent a measure of consequence of the first activity, which may comprise a numerical representation of the severity of the consequences of the activity, a category of the impact of the first activity, and any metadata where necessary. Some activities may have consequences that are environmental in nature; for example, various consumption activities users engage in may create carbon emissions. A counter activity may endeavor to counteract the environmental impact caused by such consumption activities, e.g., through carbon offsetting. For example, if the user recently flew on an airplane, the model may estimate the environmental impact of the flight, with reference to the average carbon emission of similar flights. The vector would then include a numerical estimate representing the carbon emission and energy cost of the flight, and would indicate the category of travel.

Activity generator 116 may access counter activity database(s) 136 and search for counter activities that best match the output of machine learning model 112. For example, it may use the measure of consequence of the first activity. It may classify the measure into a category and match the category against categories in counter activity database(s) 136. Activity generator 116 may calculate a percentile of the numerical estimate in the measure of consequence within its category. Within the category, activity generator 116 may look for counter activities whose score of impact rank in approximately the same percentile (e.g., within a threshold) as the percentile of the numerical estimate in the measure of consequence. Activity generator 116 may transmit its selection of one or more counter activities to notification generator 114.

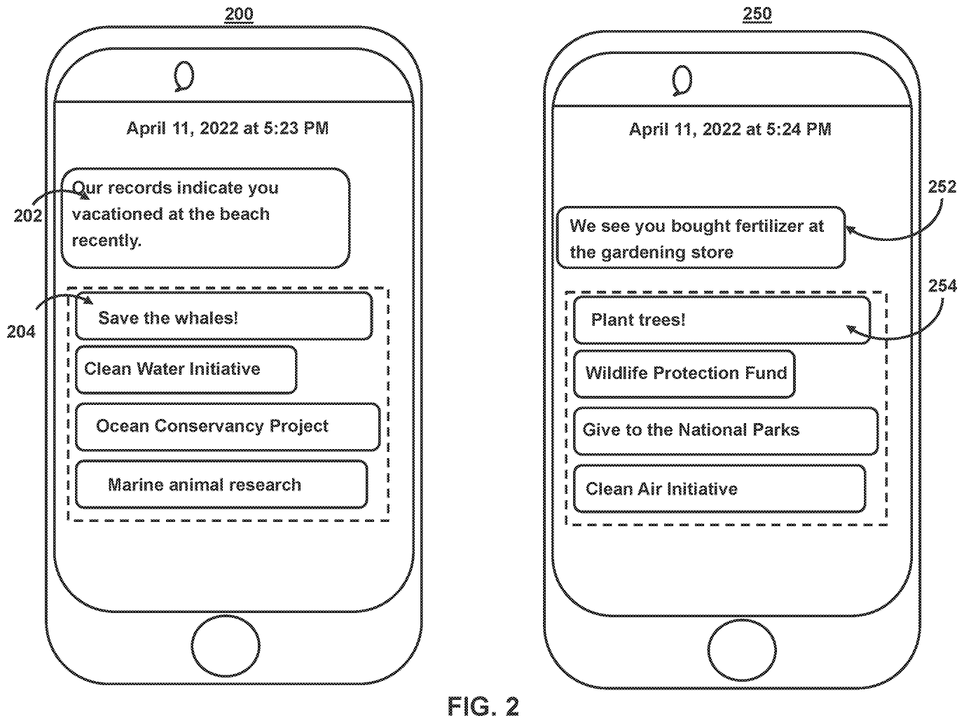

System 150 contains notification generator 114, which may communicate with a user device and display a counter activity or a selection of counter activities included in a notification on the user device. Notification generator 114 may cause the user device to display, in one or more user interfaces, content which indicates the selection of counter activities. For example, it may cause text to appear in a mobile application, as detailed in FIG. 2.

Disclosed embodiments may involve a “user interface.” A user interface may include a human-computer interaction and communication interface in a device, and it may include display screens, keyboards, a mouse, and the appearance of a desktop. For example, a user interface may comprise a way a user interacts with an application or a website. In some embodiments, the system may display notifications on user interfaces in one or more user devices which may include any kind of content.

Disclosed embodiments may include “content”. Content may include an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance.

In some embodiments, the system may use the above components in a different order. The system may receive notice of a first user activity with a corresponding location. The system may process that user activity using machine learning model 112 and generate a recommendation for a selection of counter activities. The system may access counter activity database(s) 136 to determine locations for each of the selection of counter activities. At a time subsequent to the first activity, if the system detects that user location 104 is in proximity to one of the locations for the selection of counter activities, the system may use notification generator 114 to display to the user the recommendation for a counter activity.

In some embodiments, the system may receive an indication of a first user activity with a corresponding location. The system may identify a list of authorized users relating to the first user. The authorized users may have access to activities and corresponding locations related to the first user. For example, they could be family members, authorized users of a credit card, or any appropriate contacts selected by the system. In response to detecting a second location of a second user being in proximity of the first location, the system may process the first activity and the first location using a machine learning model to determine a second activity to be executed by the second user. For example, in response to a user making reservations at a wedding venue, the system may recommend to known friends and relatives wedding gift purchases. The system may generate for display to the second user a notification indicating the second activity for execution.

FIG. 2 shows an illustrative user interface for displaying notifications on a user device to present recommendations for counter activities. For example, FIG. 2 shows user interface 200 and user interface 250. The system (e.g., a mobile application and/or a messaging application) may display choices for counter activities in a user interface (e.g., user interface 200) which in some embodiments may take place in a conversational interaction with the user. A conversational interaction may include a back-and-forth exchange of ideas and information between the system and the user. The conversational interaction may proceed through one or more mediums (e.g., text, video, audio, etc.). For example, the system may use one or more artificial intelligence models (including machine learning models, neural networks, etc.), which may be referred to herein collectively as machine learning models or simply “models.” The system may use any number of methods including, but not limited to, neural networks, classification algorithms, and clustering algorithms.

For example, the system may display a panel of choices for a counter activity in response to a first activity undertaken by the user sometime prior. In some embodiments, the system may first display a prologue reminding the user of a recent activity (e.g., a vacation) at a location (e.g., a beach). The system may then send a piece of content including choice nodes, each of which comprises a possible counter activity recommended by the machine learning model. A choice node may include content that the system may retrieve from the counter activity database in relation to the counter activity being suggested. Each counter activity (e.g., saving whales, marine animal research, etc.) may be displayed as one or more choice nodes. In user interface 200, a prologue 202 is displayed including a text prompt to help the user remember their recent activity. For example, the text prompt may help the user recall their recent vacation at the beach. A panel of choice nodes 204 is also displayed, comprising four choice nodes each corresponding to a counter activity. For example, the choice nodes may suggest counter activities like charity initiatives to save whales, to clean water, to support marine animal research, or they may advertise such nonprofit drives as the Ocean Conservancy Project. These examples are meant to counteract the user's impact on the ecosystem at the beach and the ocean. In some embodiments, the user may select one or more of the choice nodes by interacting with the user interface (e.g., clicking on an option on screen), at which point the system may display additional information about the counter activity.

In another example, user interface 250 contains prologue 252 and choice node panel 254. The prologue may relate to a recent purchase by the user at a known merchant location. For example, the system may access the location and activity information through transaction data collected by a credit card or a payment application on a user device. The system may, in the process of retrieving location and activity data, review metadata about the merchant (e.g., an environmentally conscious clientele, a marketing strategy of social responsibility, etc.), and determine a likelihood of the user to counteract the environmental repercussions of their purchases. The system may then select possible counter activities for their positive environmental impact, particularly in the realms of wildlife preservation, reforestation efforts, and the like. As shown on choice node panel 254, options that the system selects may be tailored to the particular interests of the user.

FIG. 3 shows illustrative components for a system used to generate recommendations for counter activities based on data about users' past activities and locations, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include or access databases of user activities with related location information and any associated metadata, include or access databases of counter activities which may be classified and labeled into categories, and communicate with user devices to ascertain real-time locations of users.

Cloud components 310 includes model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., categorizing activities and locations).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., what categories an activity and location may fall into).

In some embodiments, the model (e.g., model 302) may automatically perform actions based on outputs 306. In some embodiments, the model (e.g., model 302) may not perform any actions. The output of the model (e.g., model 302) may be used to label activity and location data with categories, such that counter activities may be distinguished and more accurately paired to activities.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

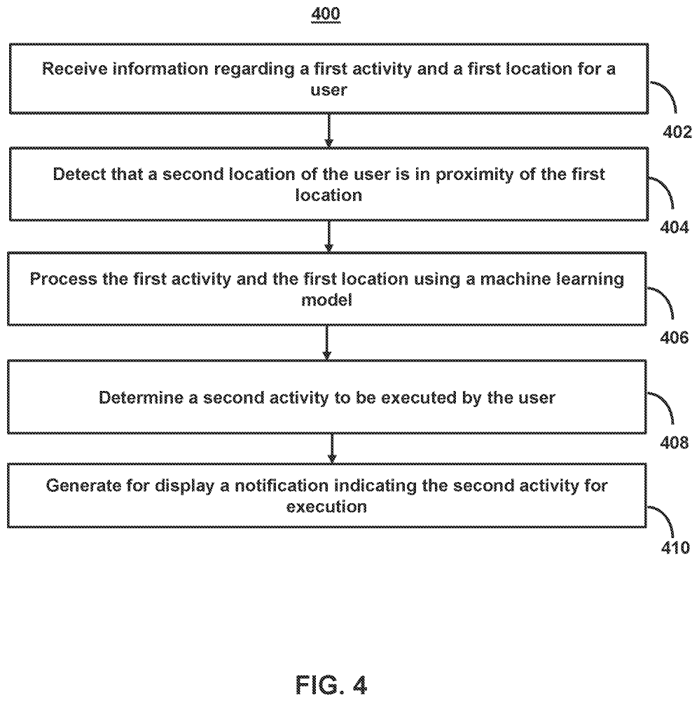

FIG. 4 shows a flowchart of the steps involved in collecting data and using one or more models to determine when and what to recommend to a user for a counter activity based on the user's previous activity, in accordance with one or more embodiments. For example, the system may use process 400 (e.g., as implemented on one or more system components described above) in order to recommend to the user, in real-time, a counter activity to address consequences of the user's previous activity.

At step 402, process 400 (e.g., using one or more components described above) receives information for a first activity at a first location for a user. For example, the system may receive information regarding a first activity and a first location for a user, the first location being a location where the first activity was executed by the user. The first location may in some embodiments correspond to user location 104 as described in FIG. 1. In some embodiments, the first activity may be a purchase at a known location. Credit card transaction data or mobile application data may inform the system of this known location. The system may infuse metadata into the information, the metadata including but not limited to purchasing patterns of this user and/or authorized users, the success of past counter activities relating to this activity, information from databases about the location. The system may store this information in user activity database(s) 134. By doing so, the system may give an accurate depiction of the activity and its location to the machine learning model.

At step 404, process 400 (e.g., using one or more components described above) detects that a second location of the user is in proximity of the first location. For example, the system may detect the user's location being in proximity of the first location via GPS tracking on a mobile device. For example, the system may acknowledge that a user has been to an amusement park at a beachfront on July 2. On July 5, the user's mobile device indicates to the system that the user is located at a different section of the beachfront. The system may calculate the distance between the two locations at the beach, and if the distance is less than a set threshold, the system may determine the user is in proximity of the prior location. In another example, the user's location may be detected when they partake in some activity traceable through a mobile application or credit card transaction data. For example, the user may purchase a television at a shopping mall on November 14. The system may receive, on November 15, notice that the user purchased a satellite dish at a store known to be located in the same shopping mall. The system may thus determine the user is in proximity of the first location. By doing so, the system may ensure that the user receives the notifications for counter activities at the appropriate location.

At step 406, process 400 (e.g., using one or more components described above) processes the first activity and the first location using a model. For example, the system may process the first activity and the first location using a machine learning model (e.g., machine learning model 112 in FIG. 1 or model 302 in FIG. 3) in order to determine a second activity to be executed by the user. The second activity may be a type of activity that is different from the first activity. For example, the second activity may be a type of activity that addresses one or more consequences from the first activity. For example, as shown in FIG. 2, the system may process a user's purchase of fertilizer at a gardening store and determine choices for a second counter activity like planting trees, protecting wildlife, giving to national parks, or cleaning air.

In some embodiments, the machine learning model may be an artificial neural network, a decision tree, a multiclass logistic regression model, a K-nearest neighbors algorithm, or some combination thereof. The model may be trained on training data for a plurality of users including user activities, locations, and measures of consequence of the user activities (e.g., user activity database(s) 134). The training process has been described above with respect to FIG. 3. In some embodiments, the system processes the first activity and the first location using the machine learning model to determine a measure of consequence of the first activity. The system may then query a database (e.g., counter activity database(s) 136 from FIG. 1) using the measure to determine the second activity to be executed by the user. The system may access, from the database, possible second activities satisfying the measure and, using a second machine learning model, cluster and label the possible second activities. The second machine learning model may comprise an artificial neural network, a K-means clustering algorithm, a gaussian mixture model, some other appropriate method, or a combination thereof. In some embodiments, the second machine learning model may be trained on training data for a plurality of counter activities and their impact data, for example from counter activity database(s) 136. The system may thus identify the second activity from the possible second activities in a process similar to described with respect to FIG. 1. By doing so, the system may assess the severity and nature of the impact of the first activity and accurately select a counter activity to negate the impact.

At step 408, process 400 (e.g., using one or more components described above) determines a second activity to be executed by the user. The second activity may be a type of activity that is different from the first activity. For example, the second activity may be a type of activity that addresses a consequence of the first activity. In some embodiments, the second activity may offset an environmental impact of the first activity. For example, a user that recently vacationed at the beach may benefit from suggestions for clean water initiatives as a counter activity, as indicated in FIG. 2. In another example, a user that has frequented fast food restaurants and who went shopping for clothing may receive recommendations for gym memberships. By doing so, the system may offer the user selections of counter activity which comprehensively capture their intention to counteract the first activity.

At step 410, process 400 (e.g., using one or more components described above) generates for display a notification indicating the second activity for execution. For example, the system may, during a time period the user is present at the second location, generate a real-time push notification in a mobile application indicating the second activity for execution. For example, the system may cause the user device to generate a notification sound to capture the user's attention. The system may use notification generator 114 from FIG. 1 to communicate with one or more user devices. In some embodiments, the system may send a notification to a user device in the form of alternate content, like an email, a text message, or a pop-up window on a mobile device. An example for a notification sent to a user inside a mobile application is shown in FIG. 2. By doing so, the system may suggest counter activities in a timely manner when the suggestions are most likely to be effective.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A system for generating real-time location-based notifications in a mobile application, the system comprising: one or more processors; and a non-transitory, computer-readable medium comprising instructions that, when executed by the one or more processors, cause operations comprising: receiving information regarding a user activity and a previous location for a user, the previous location being a location where the user activity was executed by the user; at a time subsequent to execution of the user activity by the user, detecting that a current location of the user is in proximity of the previous location; in response to detecting that the current location of the user is in proximity of the previous location, processing the user activity and the previous location using a machine learning model to determine a measure of a consequence of the user activity; querying a database using the measure to determine a counter activity to be executed by the user, the counter activity being a type of activity that addresses a consequence of the user activity; and during a time period the user is present at the current location, generating for display, in a mobile application, a notification to the user indicating the counter activity for execution.
2. A method, the method comprising: receiving information regarding a first activity and a first location for a first user, the first location being a location where the first activity was executed by the first user; in response to detecting a second location of a second user being in proximity of the first location, processing the first activity and the first location using a machine learning model to determine a second activity to be executed by the second user, the second user being authorized to access the first activity and the first location for the first user, the second activity being a type of activity that addresses a consequence of the first activity; and generating for display to the second user a notification indicating the second activity for execution.
3. A method, the method comprising: receiving information regarding a first activity and a first location for a user, the first location being a location where the first activity was executed by the user; in response to detecting a second location of the user being in proximity of the first location, processing the first activity and the first location using a machine learning model to determine a second activity to be executed by the user, the second activity being a type of activity that is different from the first activity; and generating for display to the user a notification indicating the second activity for execution.
4. The method of any one of the preceding embodiments, wherein processing the first activity and the first location using a machine learning model to determine a second activity to be executed by the user comprises: processing the first activity and the first location using the machine learning model to determine a measure of a consequence of the first activity; and querying a database using the measure to determine the second activity to be executed by the user.
5. The method of any one of the preceding embodiments, wherein querying the database using the measure to determine the second activity to be executed by the user comprises: accessing, from the database, possible second activities satisfying the measure; using a second machine learning model to cluster and label the possible second activities; and identifying the second activity from the possible second activities.
6. The method of any one of the preceding embodiments, further comprising: training the machine learning model based on training data for a plurality of users including user activities, locations, and measures of consequence of the user activities.
7. The method of any one of the preceding embodiments, wherein detecting the second location of the user being in proximity of the first location comprises detecting that the user is in proximity of the first location at a time subsequent to execution of the first activity by the user.
8. The method of any one of the preceding embodiments, wherein the second activity being a type of activity that is different from the first activity comprises the second activity being a type of activity that addresses a consequence of the first activity.
9. The method of any one of the preceding embodiments, wherein generating for display to the user a notification indicating the second activity for execution comprises: during a time period the user is present at the second location, generating a real-time push notification in a mobile application indicating the second activity for execution.
10. A tangible, non-transitory, machine-readable medium storing instructions that, when executed by a data processing apparatus, cause the data processing apparatus to perform operations comprising those of any of embodiments 1-9.
11. A system comprising one or more processors; and memory storing instructions that, when executed by the processors, cause the processors to effectuate operations comprising those of any of embodiments 1-9.
12. A system comprising means for performing any of embodiments 1-9.

What is claimed is:

1. A system for generating real-time location-based notifications in a mobile application, the system comprising:
one or more processors; and
a non-transitory, computer-readable medium comprising instructions that, when executed by the one or more processors, cause operations comprising:
receiving information regarding a user activity and a previous location for a user, the previous location being a location where the user activity was executed by the user;
at a time subsequent to execution of the user activity by the user, detecting that a current location of the user is in proximity of the previous location;
in response to detecting that the current location of the user is in proximity of the previous location, processing the user activity and the previous location using a machine learning model to determine a measure of a consequence of the user activity;
querying a database using the measure of the consequence to determine a counter activity to be executed by the user, the counter activity being a type of activity that addresses a consequence of the user activity; and
during a time period the user is present at the current location, generating for display, in a mobile application, a notification to the user indicating the counter activity for execution.

2. A method, comprising:
receiving information regarding a first activity and a first location for a user, the first location being a location where the first activity was executed by the user;
in response to detecting a second location of the user being in proximity of the first location, processing the first activity and the first location using a machine learning model to determine a second activity to be executed by the user, the second activity being a type of activity that is different from the first activity; and
generating for display to the user a notification indicating the second activity for execution.

3. The method of claim 2, wherein processing the first activity and the first location using a machine learning model to determine a second activity to be executed by the user comprises:
processing the first activity and the first location using the machine learning model to determine a measure of a consequence of the first activity; and
querying a database using the measure to determine the second activity to be executed by the user.

4. The method of claim 3, wherein querying the database using the measure to determine the second activity to be executed by the user comprises:
accessing, from the database, possible second activities satisfying the measure;
using a second machine learning model to cluster and label the possible second activities; and
identifying the second activity from the possible second activities.

5. The method of claim 3, further comprising:
training the machine learning model based on training data for a plurality of users including user activities, locations, and measures of consequence of the user activities.

6. The method of claim 2, wherein detecting the second location of the user being in proximity of the first location comprises detecting that the user is in proximity of the first location at a time subsequent to execution of the first activity by the user.

7. The method of claim 2, wherein the second activity being a type of activity that is different from the first activity comprises the second activity being a type of activity that addresses a consequence of the first activity.

8. The method of claim 2, wherein generating for display to the user a notification indicating the second activity for execution comprises:
during a time period the user is present at the second location, generating a real-time push notification in a mobile application indicating the second activity for execution.

9. A non-transitory, computer-readable medium storing instructions that, when executed by one or more processors, cause operations comprising:
receiving information regarding a first activity and a first location for a first user, the first location being a location where the first activity was executed by the first user;
in response to detecting a second location of a second user being in proximity of the first location, processing the first activity and the first location using a machine learning model to determine a second activity to be executed by the second user, the second user being authorized to access the first activity and the first location for the first user, the second activity being a type of activity that addresses a consequence of the first activity; and
generating for display to the second user a notification indicating the second activity for execution.

10. The non-transitory, computer-readable medium of claim 9, wherein processing the first activity and the first location using a machine learning model to determine a second activity to be executed by the second user comprises:
processing the first activity and the first location using the machine learning model to determine a measure of a consequence of the first activity; and
querying a database using the measure to determine the second activity to be executed by the second user.

11. The non-transitory, computer-readable medium of claim 10, wherein querying the database using the measure to determine the second activity to be executed by the second user comprises:
accessing, from the database, possible second activities satisfying the measure;
using a second machine learning model to cluster and label the possible second activities; and
identifying the second activity from the possible second activities.

12. The non-transitory, computer-readable medium of claim 10, further comprising:
training the machine learning model based on training data for a plurality of users including user activities, locations, and measures of consequence of the user activities.

13. The non-transitory, computer-readable medium of claim 9, wherein detecting the second location of the second user being in proximity of the first location comprises detecting that the second user is in proximity of the first location at a time subsequent to execution of the first activity by the first user.

14. The non-transitory, computer-readable medium of claim 9, wherein the second activity being a type of activity that is different from the first activity comprises the second activity being a type of activity that addresses a consequence of the first activity.

15. The non-transitory, computer-readable medium of claim 9, wherein generating for display to the second user a notification indicating the second activity for execution comprises:
during a time period the second user is present at the second location, generating a real-time push notification in a mobile application indicating the second activity for execution.
